(19) United States
(12) Patent Application Publication
(10) Pub. No.: US 2023/0257086 A1
(43) Pub. Date: Aug. 17, 2023

(54) AUTOMATIC METHOD FOR RELEASING AND GUIDING RESCUE AND LIFE-SAVING APPLIANCES THAT IMPLEMENT THE METHOD

(71) Applicant: Jorge Alberto FERREIRA NORAS, Torres Vedras (PT)

(72) Inventor: Jorge Alberto FERREIRA NORAS, Torres Vedras (PT)

(21) Appl. No.: 18/012,234

(22) PCT Filed: May 29, 2020
(86) PCT No.: PCT/IB2020/055106

§ 371 Date: Dec. 22, 2022

(30) Foreign Application Priority Data
May 6, 2020 (PT) 116338

(51) Int. Cl. B63C 9/00; B64U 10/00; B64U 70/93; B63C 9/08; B64U 80/84

(52) U.S. Cl. CPC B63C 9/00; B63C 9/0011; B63C 9/082; B64U 10/00; B64U 70/93; B64U 80/84; B64U 2101/20

(57) ABSTRACT

This invention relates to an automatic method for releasing and guiding rescue and life-saving appliances that implement the method, implemented by a computer located in the command tower (202) of the vessel (200), that receives and processes in real time the geographical position data of a person overboard (101) in response to an emergency signal received by the aerial (3), sends a signal activating and releasing the Unmanned Surface Vehicle - USV - (1), launching it onto the water, and the Unmanned Aerial Vehicle - UAV - (4),launching it into the air.

This invention relates to an automatic method for releasing and guiding rescue and life-saving appliances that implement the method.

### BACKGROUND

Self-propelled, u-shaped rescue vehicles have proven to be particularly effective when rescuing people from the sea, rivers and reservoirs, and at the present time there is strong demand for this alternative to the traditional rescue appliances, namely lifebuoys.

The speed of intervention and rescue, coupled with the option of remote control over the rescue appliance, are the reasons behind the said demand from the owners of leisure and professional vessels, cruise ships, maritime authorities and coastal bathing area managers.

The state of the art closest to this invention is the system and method described and disclosed in national patent of invention n° PT 116052.

An auto-rescue method is disclosed by which, in response to an alarm triggered by a personal beacon, the rescue appliance is released. The appliance consists of an unmanned, u-shaped vehicle. However, it has been found that, especially when weather and sea conditions are difficult, communications between the person overboard and the command centre and the rescue vehicle are key to the rescue operation’s effectiveness and efficiency. This invention covers a method and system that adds an additional device to the automatic rescue operation: an UAV (Unmanned Aerial Vehicle) or drone.

### THE INVENTION

The use of USVs (Unmanned Surface Vehicles) in water, to rescue people who are in difficulty in water, is becoming increasingly frequent. The quality of the communication of the person’s location is key in the type of rescue that employs these means. The invention referred to in the background uses a personal beacon, usually attached to the user’s wristband. Now the signal emitted by this type of beacon is often of poor quality, either because the wristband is underwater as the wearer struggles to stay afloat, or because of the waves or wind that prevent the signal from having sufficient range, that is to reach the telecommunications tower that is in a safe location, either on a vessel or on land. In addition, if the safe place is on a vessel travelling at a relatively high speed, say 20 knots, just 30 seconds after the person fell overboard they will be at a linear distance of 300 metres from the vessel. For a better understanding of how dramatic the situation is, think of an Olympic-size swimming pool which is 50 metres long. The distance the person overboard has to cover to reach safety just thirty seconds after they fell in the water is equal to 6 Olympic-size swimming pools.

Thus one aim of this invention is to provide an automatic method of rescuing a person overboard that is safe and reliable since the means employed are released speedily and travel at compatible speeds, since communication between the invention’s various technical devices is conducted easily and smoothly and since it ensures that when the signal reaches the technical recipient of the invention it is of a quality that can be handled by the said signal recipient’s processor.

One aim of the invention is to ensure that the guiding of the USV towards the person in difficulty in the water is conducted by way of a drone or UAV because these devices have a better response time than an USV, since they can fly at speeds up to five times the speed of an USV, i.e. at around 160 km/h. Therefore, as soon as the invention controller detects the incident, in addition to activating and releasing the USV, configured to receive and transport the person in difficulty in the water, for instance a U-shaped vehicle, they also activate and release an UAV, or drone, equipped with signal reception and transmission equipment, which as soon as it detects a RF signal emitted by a Personal Alarm Beacon pairs with it, and maintains the same geographical position as the geographical position of the Personal Alarm Beacon and sends location data to the controller in the command tower.

This invention provides a water rescue system as defined in claim 1.

For a better understanding of this invention a description will now be given of the preferred configuration, although it is purely for illustrative purposes, as per the attached drawings, in which:

### DESCRIPTION OF FIGURES

FIG. 1 shows the rear of a vessel where the USV is stowed, and which in this example is motorised, u-shaped buoy, as per the invention;

FIG. 2 shows the vessel that transports the invention system at the time of the incident and the consequent synchronised release of the rescue appliance, as per the invention;

FIG. 3 is a diagram of the USV and the UAV in operational communication with the command tower at the base station, heading towards the location of the person overboard;

FIG. 4 is a diagram of the rescue appliances returning to the base station with the person supported by the USV;

FIG. 5 is a diagram of a scenario for the invention’s rescue method where the base station is on land and the UAV is supported by a pontoon boat;

FIG. 6 shows the flowchart for signal and data processing in the invention’s controller.

### DETAILED DESCRIPTION OF PREFERRED WAYS OF IMPLEMENTING THE INVENTION

The essential components of the automatic release and guiding of rescue appliances method are a Personal Signal Emitting Beacon (102), an USV – Unmanned Surface Vehicle (1), and an UAV – Unmanned Aerial Vehicle (4).

The UAV (4), the Personal Signal Emitting Beacon (102), and the USV (1), all contain a tracker which calculates their geographical position in real time. The same is true of the Base Station.

Under a preferred way of implementing the invention the tracker can be a GPS device. However, the invention may be employed when using other types of tracker. For example, the person’s location may be calculated by way of triangulating an acoustic signal, or in another preferred manner by way of surveillance cameras linked to the systems components.

The USV (1) incorporates an electronic module, which houses the said tracker, a signal receiver/transmitter, and a processor that processes the signals received from the Personal Signal Emitting Beacon (102), from the UAV (4), or from the Command Tower’s (202) aerial (3).

Two types of signal may be emitted: alarm and location, coded according to the transmission/reception frequency.

The USV processor is equipped with signal processing and data processing equipment, and is connected operationally to the propellers. The processor can alter the position and speed of the propellers.

As per the invention, the Command Tower (202) houses a computer that includes a processor where software has been installed that allows it to perform the following functions:
in response to an emergency signal issued by a Personal Alarm Beacon (102) and received by aerial (3), it sends a synchronised activation and release signal: i) the Unmanned Surface Vehicle - USV (1), on support (2), is launched onto the surface of the water, and ii) the Unmanned Aerial Vehicle - UAV (4), which is stationed on its platform (5) is launched into the air;
it receives and processes in real time the geographical position data emitted by the Personal Alarm Beacon (102), so as to guide the UAV (4) to the location of the person overboard (101) who is wearing the Personal Alarm Beacon (102);
it pairs the UAV (4) and the Personal Alarm Beacon (102), as soon as the UAV’s geographical position is substantially the same as that of the Personal Alarm Beacon (102);
it receives and processes in real time the geographical position data of the UAV (4) after the pairing, so as to guide the UAV (4) and maintain it in the same geographical position as the Personal Alarm Beacon (102);
it receives and processes in real time the geographical position data of the UAV (4) and the geographical position data of the USV (1) so as to set and correct a rescue course in real time and send directional control signals to the USV (1) so that the USV (1) heads to the coordinates of the UAV (4) which match the coordinates of the Personal Alarm Beacon (102).

Under another preferred implementation of the automatic release and guiding of rescue appliances method, in addition and after detecting the presence of a human being on the USV (1), it receives and processes in real time the UAV (4) geographical position data and the USV (1) geographical position data and sends directional control signals to the USV (1) to guide the USV (1) to a safe location.

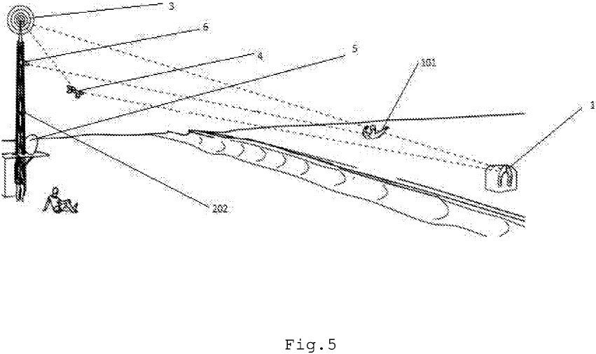

The safe location is preferably a place on land. Nonetheless, the safe location may be a place on the water such as a vessel or a pontoon boat. The safe location is preferably the vessel equipped with the rescue appliances, USV and UAV. Equally preferable is the vessel out of which the person to be rescued fell. In another version the safe location is a pontoon boat floating outside of the zone in which waves break on a beach (see FIG. 5). In yet another version the safe location is a beach.

The invention method may operate in such a way that once a human being has been detected on the USV (1) by way of sensors, the processor is configured to plot a course to a safe location and send signals guiding the USV (1) to the said location.

However, and a preferred manner, as an alternative or in addition, the USV may be fitted with a presence button so that a human being’s presence on the USV is detected when the presence button is pressed.

At any time during the rescue, as per claim 2, the automatic release and guiding of rescue appliances method may, preferably, be overridden and controlled manually by an operator.

Under a preferred way of implementing the invention and in addition, the position, image and sound data received are data collected by a camera, so that the position may be calculated by supplementary means and it is possible to enter into visual and audio contact with the person overboard.

The invention incorporates an Unmanned Surface Vehicle -USV - (1), fitted with a processor that acts upon the means of communication, propulsion and steering, and which cooperates with the processor in the command tower (202), enabling it to adopt the automatic release and guiding of rescue appliances method.

The Unmanned Surface Vehicle - USV - (1) is preferably a U-shaped vehicle.

The invention includes an Unmanned Aerial Vehicle - UAV -(4), fitted with a processor that acts upon the means of communication, propulsion and steering, and which cooperates with the processor in the command tower (202), enabling it to adopt the automatic release and guiding of rescue appliances method.

The invention also includes a Personal Alarm Beacon (102), fitted with a processor that acts upon the means of communication, transmitting alarm and positional signals, and which cooperates with the processor in the command tower (202), so as to adopt the automatic release and guiding of rescue appliances method.

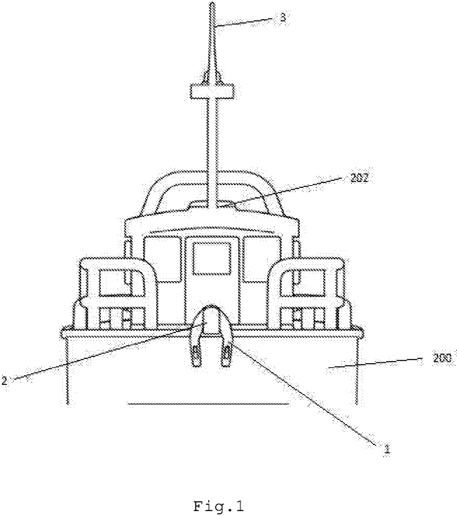

FIG. 1 shows a vessel (200) fitted with some of the invention devices: a vessel whose stern contains an USV (1) held by a bayonet support (2), capable of ensuring speedy release of the USV (1), whenever a signal emitted by the aerial (3) is received by the USV (1). A communications and operational link is established between the USV (1) and the command tower (202), by means of RF signals transmitted by the aerial (3) and received by the aerial incorporated in the USV.

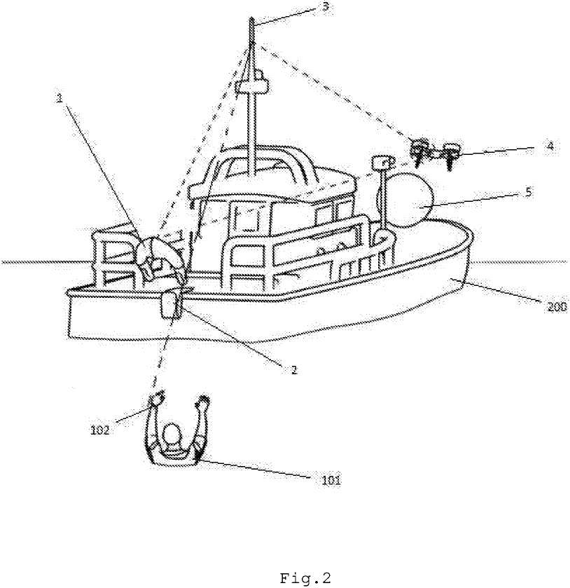

FIG. 2 illustrates when the invention is activated by the various technical components: the person in difficulty in the water (101) sounds the alarm by way of the Personal Alarm Beacon (102), and the life-saving appliances USV (1) and UAV (4) are immediately released from the bayonet support (2) and the dome (5). The signal emitted by the Personal Alarm Beacon (102) is captured by the aerial (3) located on the vessel (200), and is processed in the command tower (202) in order to guide the UAV to the geographical coordinates of the Personal Alarm Beacon (102) . The USV (1) receives from the command tower (202) directions to the geographical coordinates of the Personal Alarm Beacon.

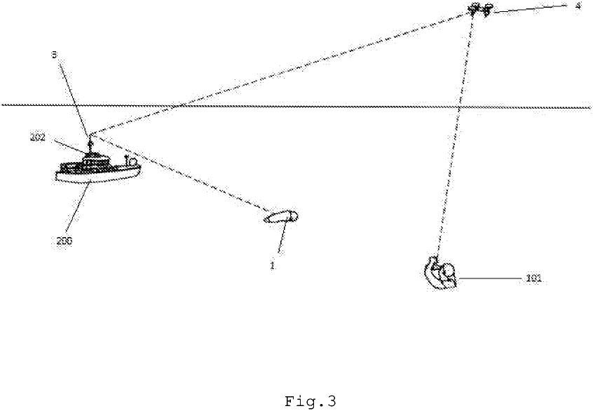

FIG. 3 also illustrates the invention method, when the vessel (200) has travelled a considerable distance from the person overboard (101). Once the UAV (4) has been paired with the Personal Alarm Beacon (102), the command tower (202), where the controller is located, sends RF signals by way of the aerial (3) to guide the USV (1) to the geographical coordinates of the UAV (4).

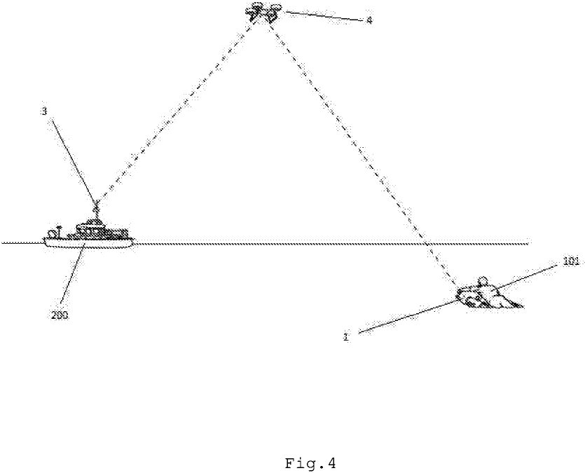

FIG. 4 shows the invention method after the presence of a human being has been detected on the USV (1), which triggers the USV’s (1) return to a safe location, in this case the actual vessel out of which the person fell. The UAV, paired with the USV, allows the communications and operational link to be established with the controller located in the vessel’s (200) command tower.

FIG. 5 shows the invention method being employed on a beach. The command tower is on land and the lower part houses the UAV’s platform and protective dome (5). The safe location can be a pontoon boat, located outside of the zone where the waves break, to which the USV is fastened. When an incident occurs the Personal Alarm Beacon (101) is activated and the communications and operational link between it and the USV (1), the UAV (4) and the command tower (202) is established. The UAV searches for the Personal Alarm Beacon’s (101) position and uses it to establish communicational pairing to ensure that the signal containing the person’s geographical position is not lost. In the meantime the USV (1) is on route, heading towards the coordinates that it receives from the command tower (202) which the latter received from the UAV (4).

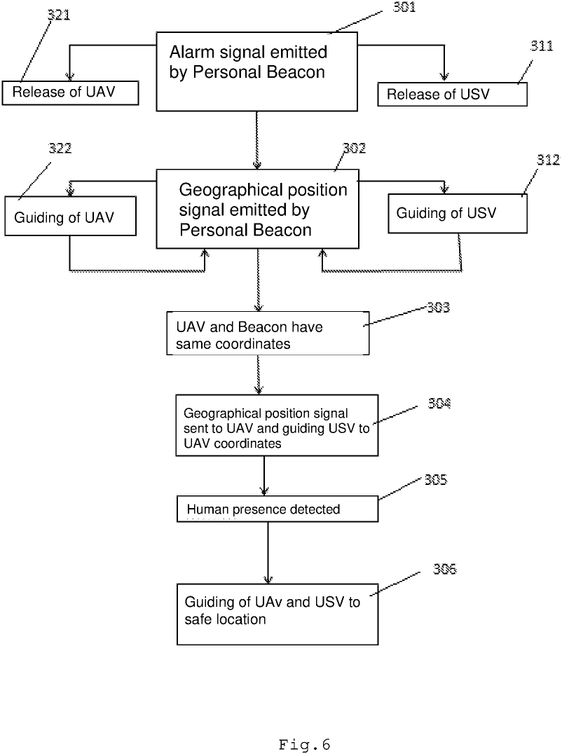

FIG. 6 is a flowchart showing how the invention processes signals and data. Once the Personal Alarm Beacon has been activated, a signal (301) is emitted that will be processed by the invention’s controller, so as to trigger the release of the USV (311) and the UAV (321). The aerial captures the signals (302), in which is encoded the geographical position of the Personal Alarm Beacon, which is fitted with a GPS device or another locator and an aerial. These signals are processed in order to guide both the UAV (322) and the USV (312) to the geographical coordinates of the Personal Alarm Beacon. Since it travels faster the UAV will tend to arrive at the scene first, and it will be paired with the Beacon (303) and it will communicate the coordinates to the command tower (304). When the UAV and the USV share the same coordinates it means the UAV, the USV and the Personal Beacon are aligned geographically. When the presence of a human being on the USV (305) is detected, either automatically or physically, the process of guiding the USV to a safe location (306) begins.

Finally, it is clear that the guiding system and method described and illustrated herein, as well as the Personal Beacon, the UAV and the USV, configured to implement the invention method, may be modified and altered without stepping outside the scope of this invention’s protection, as defined in the attached claims.

1. Automatic method for releasing and guiding rescue appliances, implemented by a computer housed in a command tower (202), the said computer includes a processor where software has been installed that allows it to perform the following functions:
in response to an emergency signal issued by a Personal Alarm Beacon (102) and received by aerial (3), it sends a synchronised activation and release signal: i) the Unmanned Surface Vehicle - USV (1), on support (2), is launched onto the surface of the water, and ii) the Unmanned Aerial Vehicle - UAV (4), which is stationed on its platform (5) is launched into the air;
it receives and processes in real time the geographical position data emitted by the Personal Alarm Beacon (102), so as to guide the UAV (4) to the location of the person overboard (101) who is wearing the Personal Alarm Beacon (102);
it pairs the UAV (4) and the Personal Alarm Beacon (102), as soon as the UAV’s geographical position is substantially the same as that of the Personal Alarm Beacon (102);
it receives and processes in real time the geographical position data of the UAV (4) after the pairing, so as to guide the UAV (4) and maintain it in the same geographical position as the Personal Alarm Beacon (102);
it receives and processes in real time the geographical position data of the UAV (4) and the geographical position data of the USV (1) so as to set and correct a rescue course in real time and send directional control signals to the USV (1) so that the USV (1) heads to the coordinates of the UAV (4) which match the coordinates of the Personal Alarm Beacon (102).

2. The method according to claim 1, characterised by, in addition and after detecting the presence of a human being on the USV (1), receiving and processing in real time the UAV (4) geographical position data and the USV (1) geographical position data and sending directional control signals to the USV (1) to guide the USV (1) to a safe location.

3. The method according to claim 2, characterised by the safe location being on land.

4. The method according to claim 2, characterised by the safe location being on the surface of the water, such as a vessel or a pontoon boat.

5. The method according to claim 2, characterised by the detection of a human being on the vehicle being undertaken by sensors.

6. The method according to claim 2, characterised by the detection of a human requiring the pressing of a button on the USV.

7. The method according to claim 2, characterised by the possibility, at any time during the rescue, of the system being overridden and controlled manually by an operator.

8. The method according to claim 7, and in addition the data received is data collected by a camera.

9. An ensemble comprising an unmanned Surface Vehicle - (USV) - (1), fitted with a processor that acts upon the means of communication, propulsion and steering, and a command tower (202) comprising a computer in turn comprising a processor, the (USV) cooperating with the processor in the command tower (202), wherein the ensemble is configured to implement an automatic method for releasing and guiding rescue appliances, the said processor being configured with software that allows it to perform the following functions:
in response to an emergency signal issued by a Personal Alarm Beacon (102) and received by aerial (3), it sends a synchronised activation and release signal: i) the Unmanned Surface Vehicle - USV (1), on support (2), is launched onto the surface of the water, and ii) the Unmanned Aerial Vehicle - UAV (4), which is stationed on its platform (5) is launched into the air;
it receives and processes in real time the geographical position data emitted by the Personal Alarm Beacon (102), so as to guide the UAV (4) to the location of the person overboard (101) who is wearing the Personal Alarm Beacon (102);
it pairs the UAV (4) and the Personal Alarm Beacon (102), as soon as the UAV’s geographical position is substantially the same as that of the Personal Alarm Beacon (102);
it receives and processes in real time the geographical position data of the UAV (4) after the pairing, so as to guide the UAV (4) and maintain it in the same geographical position as the Personal Alarm Beacon (102);
it receives and processes in real time the geographical position data of the UAV (4) and the geographical position data of the USV (1) so as to set and correct a rescue course in real time and send directional control signals to the USV (1) so that the USV (1) heads to the coordinates of the UAV (4) which match the coordinates of the Personal Alarm Beacon (102).

10. The ensemble according to claim 9 wherein the Unmanned Surface Vehicle - USV - (1), is a U-shaped vehicle.

11. The ensemble according to claim 9 wherein the Unmanned Aerial Vehicle - UAV - (4) is fitted with a processor that acts upon the means of communication, propulsion and steering, and which cooperates with the processor in the command tower (202).

12. The ensemble according to claim 9 wherein the Personal Alarm Beacon is fitted with a processor that acts upon the means of communication, transmitting alarm and positional signals, and which cooperates with the processor in the command tower (202).
